(19) United States
(12) Patent Application Publication
(10) Pub. No.: US 2022/0034124 A1
(43) Pub. Date: Feb. 3, 2022

(54) LOCK MECHANISM

(71) Applicant: The Foot Lock Industries LLC, Henderson, NV (US)

(72) Inventors: Wasseem Elkhatib, Henderson, NV (US); Ahmad El-Khatib, Henderson, NV (US); Grega Jerman, Las Vegas, NV (US); Milos Jerman, Las Vegas, NV (US)

(73) Assignee: The Foot Lock Industries LLC, Henderson, NV (US)

(21) Appl. No.: 16/942,778

(22) Filed: Jul. 30, 2020

(51) Int. Cl. E05B 53/00; E05C 19/00; E05B 65/00; E05B 47/00

(52) U.S. Cl. CPC E05B 53/001; E05C 19/003; E05Y 2900/132; E05B 47/0038; E05Y 2900/112; E05B 65/0035

(57) ABSTRACT

A lock mechanism includes a pedal, a vertical rod, a rod support, a hinge, a hinge support, a hinge lock, and magnets. When the pedal is pushed up the vertical rod, the hinge will lower into a cavity of the hinge lock and the lock mechanism will be in a “locked” mode. To “unlock” the lock mechanism, the user pushes the pedal down the vertical rod, then the hinge will raise out of the cavity of the hinge lock and now the lock mechanism will be in an “unlocked” mode. Then when the user wants to lock the lock mechanism while being inside a bathroom stall, the user will align a door with a wall/stand of the bathroom stall and then push the pedal up so the hinge will lower into the cavity of the hinge lock and the lock mechanism will be in a “locked” mode.

### TECHNICAL FIELD

The present disclosure relates to a lock mechanism. More specifically, the present disclosure relates to a lock mechanism for a bathroom door/stall.

### BACKGROUND

Current methods of opening, closing, locking and unlocking a public restroom door/stall are limited by the use of only a person's hand and especially the lock mechanism in a public restroom is only currently locked and unlocked by using a person's hand. There are currently different types of locks, but all are made for the functionality of using your hand.

Applicant's disclosure provides a device and/or apparatus which allows a public restroom door/stall to be opened, closed, locked and unlocked in a safe and hygienic manner, which solves the problem of preventing the spread of COVID-19 and other diseases as well as solving the problem of allowing disabled personnel to easily open, close, lock and unlock the public restroom door/stall. Applicant's disclosure teaches a device and/or apparatus, which can be a mechanical or a combination of an electro-mechanical device and/or apparatus which allows for different methods of opening, closing, locking and unlocking a public restroom door/stall instead of using a person's hand.

### SUMMARY

The disclosure is a lock mechanism designed to allow a person or others to lock and unlock a door and/or a public restroom door/stall without using the person's hand and even to open and close the door without using the person's hand. The lock mechanism comprises a pedal, a (vertical) rod, a rod support, a lock means such as a hinge, a hinge support, a hinge lock, and magnet(s). At a bottom portion or a bottom end of the lock mechanism is the pedal attached to the rod using a weld, any type of bracket and screws or any equivalent attachment means such as holes and fasteners, where the fasteners may be screws, rivets or any other equivalent attachment device(s) or apparatus. In a middle portion of the lock mechanism and/or rod, there is/are magnet(s) that work against gravity for the function of holding a lock means in place when locked. In this general location or in the same location of the middle portion of the lock mechanism and/or rod there is the rod support holding the rod against the door/stall to keep the rod vertical at all times. The rod support also houses an additional/partner magnet. On top of the vertical rod, there is a hole, which is used for attaching the hinge. The hinge is connected to the vertical rod using a clevis pin or equivalent attaching device(s) or apparatus such as screw(s) or rivet(s). The hinge has a groove therein, which enables the hinge to slide up and down. Behind the groove, there is the hinge support, which attaches/sets the hinge to the door/stall with the clevis pin. The hinge can slide on this clevis pin with the function of pushing the pedal down or up the vertical rod. When the pedal is pushed up (up the vertical rod) the hinge will lower into a cavity of the hinge lock and the lock mechanism will be in a “locked” mode. To “unlock” the lock mechanism, the user is to push the pedal down (down the vertical rod), then the hinge will raise out of the cavity of the hinge lock and now the lock mechanism will be in an “unlocked” mode. Then when the user wants to lock the lock mechanism, the user will align the door with the wall/stand of a bathroom stall and then push the pedal up so the hinge will lower into the cavity of the hinge lock and the lock mechanism will be in a “locked” mode and also the bathroom door will now be locked. The hinge lock will be attached/placed on a fixed wall/stand that adjoins with the door. Because the pedal is up when locked, the pedal cannot be seen nor opened from outside the enclosed stall if properly installed allowing for safety and solving the problem of allowing the door from being opened by someone outside of the enclosed stall. Therefore, the disclosed invention and lock mechanism prevents someone or something from opening the locked door from outside of the enclosed stall.

The lock mechanism can be placed at any height on the door/stall. The lock mechanism can be operated by a user's feet, knee, hips, or any other part of the user's leg.

Also, the size of any and/or all components of the lock mechanism can be easily, quickly and appropriately adjusted before installation. The height of the lock mechanism can be adjusted to a preferred size, when installing the lock mechanism.

The lock mechanism can be used as an add on to any door with an existing lock.

The lock mechanism can also be installed/placed on a door that does not yet have a lock.

The lock mechanism use is to lock the door and keep unwanted people from entering.

Since the lock mechanism is simple and easy to install, use and operate, any person of almost any height, size and age as well as a disabled person, can safely operate the lock mechanism.

The components of the lock mechanism may be made from metal, composite materials, alloys, plastics, rubber, wood, carbon, foam or equivalent materials which can withstand the forces of opening, closing and operating the disclosed device and/or apparatus.

Instead of a magnet(s), the use of a spring can be used to allow the hinge of the lock mechanism to be in the lock position. This makes it easier to use as you only need to push the pedal down, align the door with the wall/stand of a bathroom stall and release to hinge from the locked position.

The hinge lock can be redesigned and placed on any type of bathroom stall fixture, whether the fixture is on a parallel or perpendicular side of the door.

The lock mechanism can be retrofitted to existing doors and provided to manufacturers of bathroom stalls as add on option.

The hinge can be in a different shape, such as a curved or wavy shape and does not have to be in a sliding mechanism and can be used by an up and down (i.e. vertical) or a side-to side (i.e. horizontal, no angular position relative to the ground and/or floor, movement) methods/movements instead of an angular, relative to the ground and/or floor, movement/position.

### BRIEF DESCRIPTION OF THE DRAWINGS

In order to more clearly illustrate the embodiments of the present disclosure, a brief description of the drawings is given below. The following drawings are only illustrative of some of the embodiments of the present disclosure and for a person of ordinary skill in the art, other drawings or embodiments may be obtained from these drawings without inventive effort.

FIG. 1 is a schematic perspective front view of the lock mechanism.

FIG. 2 is a schematic front view of the lock mechanism attached to a bathroom door/stall.

FIG. 3 is a schematic perspective view of the lock mechanism in a locked/closed position and attached to a bathroom door/stall.

FIG. 4 is a schematic perspective view of the lock mechanism in an unlocked/open position where a pedal has been moved to a lower position/location on a vertical rod of the lock mechanism.

FIG. 5 is a schematic perspective view of the lock mechanism in a locked/closed position where the pedal has been moved to an upper/higher position/location on the vertical rod of the lock mechanism.

FIG. 6 is a schematic perspective front view of a hinge lock.

FIG. 7 is a schematic side view of the hinge lock.

FIG. 8 is a schematic front view of the hinge lock.

FIG. 9 is a schematic perspective back view of a rod support.

FIG. 10 is a schematic perspective front view of the rod support.

FIG. 11 is a schematic back view of the rod support.

FIG. 12 is a schematic side view of the rod support.

FIG. 13 is a schematic front view of the rod support.

FIG. 14 is a schematic perspective top view of a pedal.

FIG. 15 is a schematic top view of the pedal.

FIG. 16 is a schematic side view of the pedal.

FIG. 17 is a schematic perspective view of a (vertical) rod.

FIG. 18 is a schematic front view of the rod.

FIG. 19 is a schematic top view of the rod.

FIG. 20 is a schematic front view of the rod.

FIG. 21 is a schematic detailed view of section A in FIG. 20.

FIG. 22 is a schematic perspective view of a hinge.

FIG. 23 is a schematic top view of the hinge.

FIG. 24 is a schematic front view of the hinge.

FIG. 25 is a schematic perspective front view of a hinge support.

FIG. 26 is a schematic front view of the hinge support.

FIG. 27 is a schematic side view of the hinge support.

FIG. 28 is another schematic front view of the hinge support.

FIG. 29 illustrates springs being used to allow the hinge of the lock mechanism to be in the lock position.

### DETAILED DESCRIPTION

The technical solutions of the present disclosure will be clearly and completely described below with reference to the drawings. The embodiments described are only some of the embodiments of the present disclosure, rather than all of the embodiments. All other embodiments that are obtained by a person of ordinary skill in the art on the basis of the embodiments of the present disclosure without inventive effort shall be covered by the protective scope of the present disclosure.

In the description of the present disclosure, it is to be noted that the orientational or positional relation denoted by the terms such as “center”, “upper”, “lower”, “left”, “right”, “vertical”, “horizontal”, “inner” and “outer” is based on the orientation or position relationship indicated by the figures, which only serves to facilitate describing the present disclosure and simplify the description, rather than indicating or suggesting that the device or element referred to must have a particular orientation, or is constructed or operated in a particular orientation, and therefore cannot be construed as a limitation on the present disclosure. In addition, the terms “first”, “second” and “third” merely serve the purpose of description and should not be understood as an indication or implication of relative importance.

In the description of the present disclosure, it should be noted that unless otherwise explicitly specified and defined, the terms “install”, “link” and “connect” shall be understood in the broadest sense, which may, for example, refer to fixed connection, detachable connection or integral connection; may refer to mechanical connection or electrical connection; may refer to direct connection or indirect connection by means of an intermediate medium; and may refer to communication between two elements. A person of ordinary skill in the art would understand the specific meaning of the terms in the present disclosure according to specific situations.

The present disclosure of a lock mechanism is described in detail below in reference to the figures.

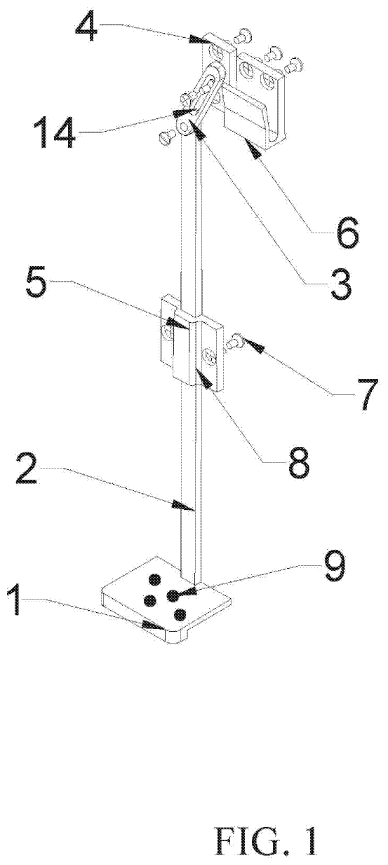

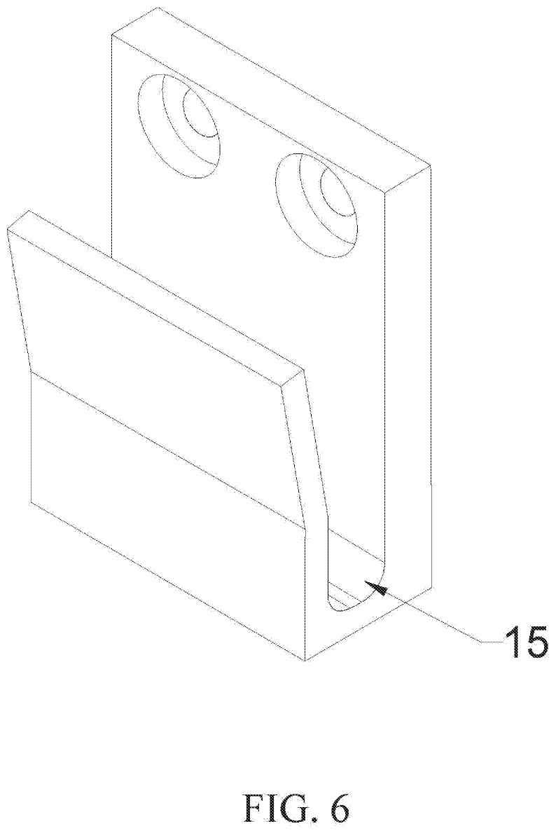

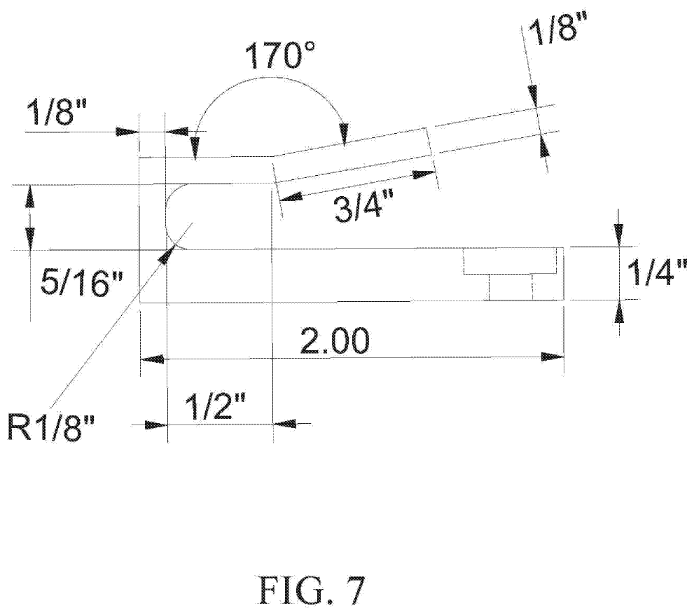

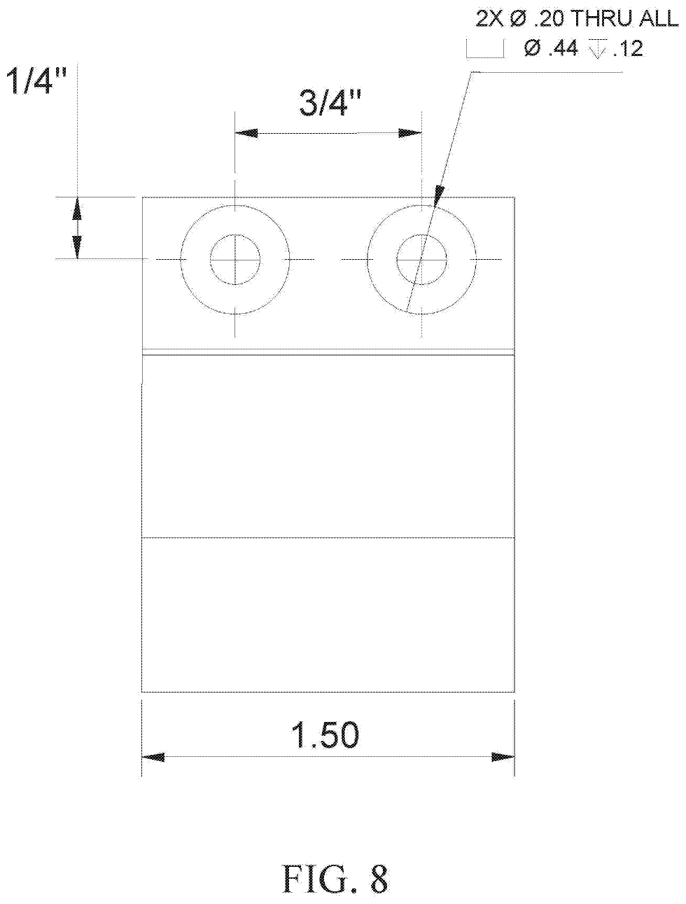

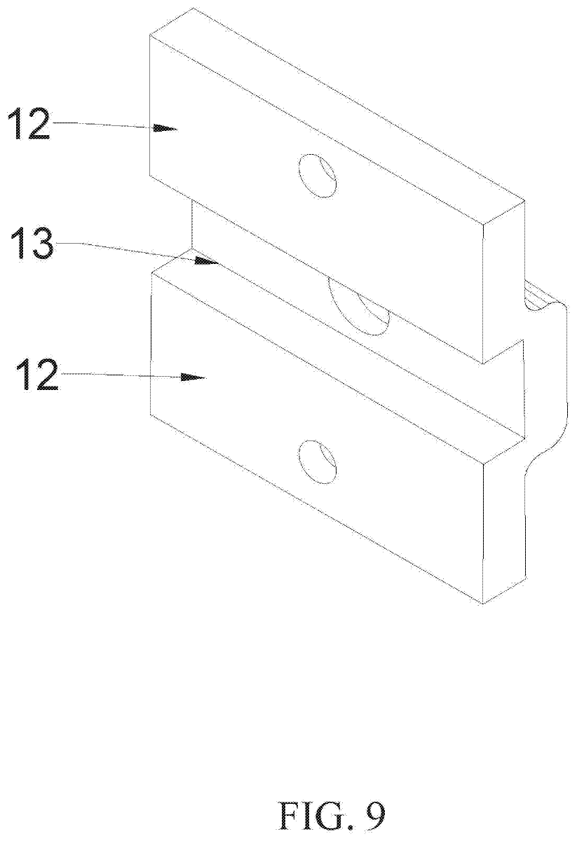

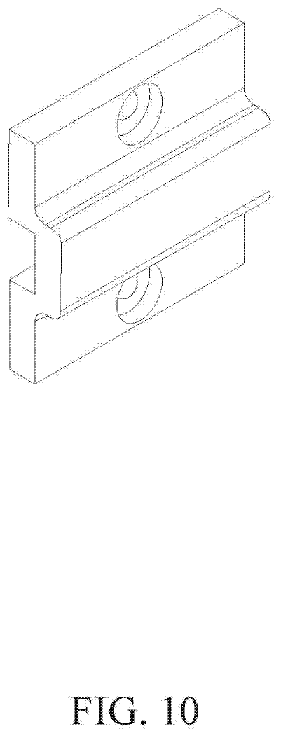

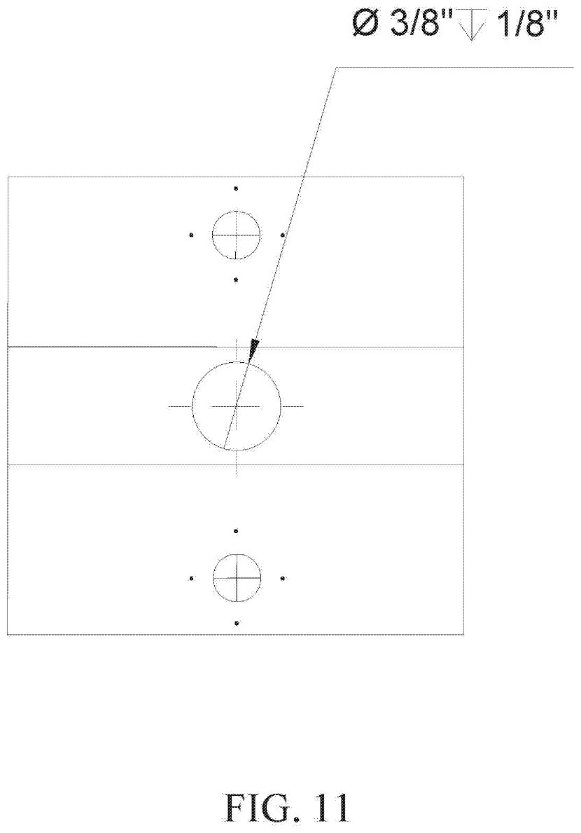

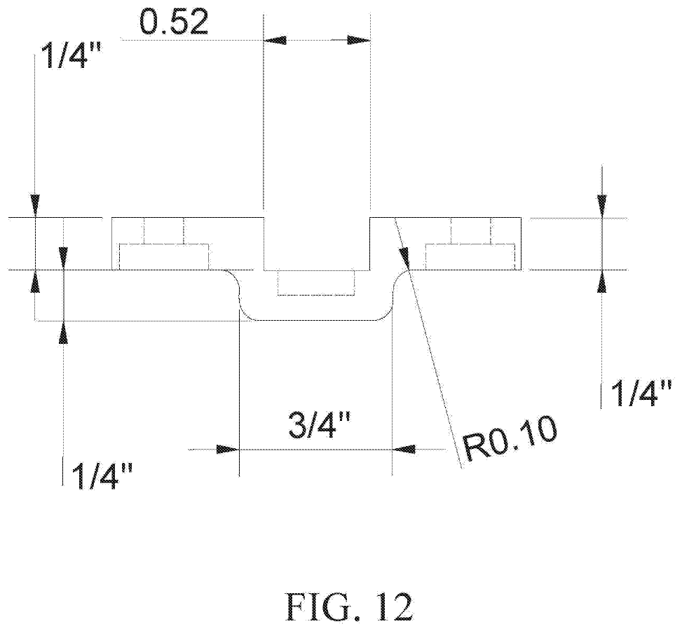

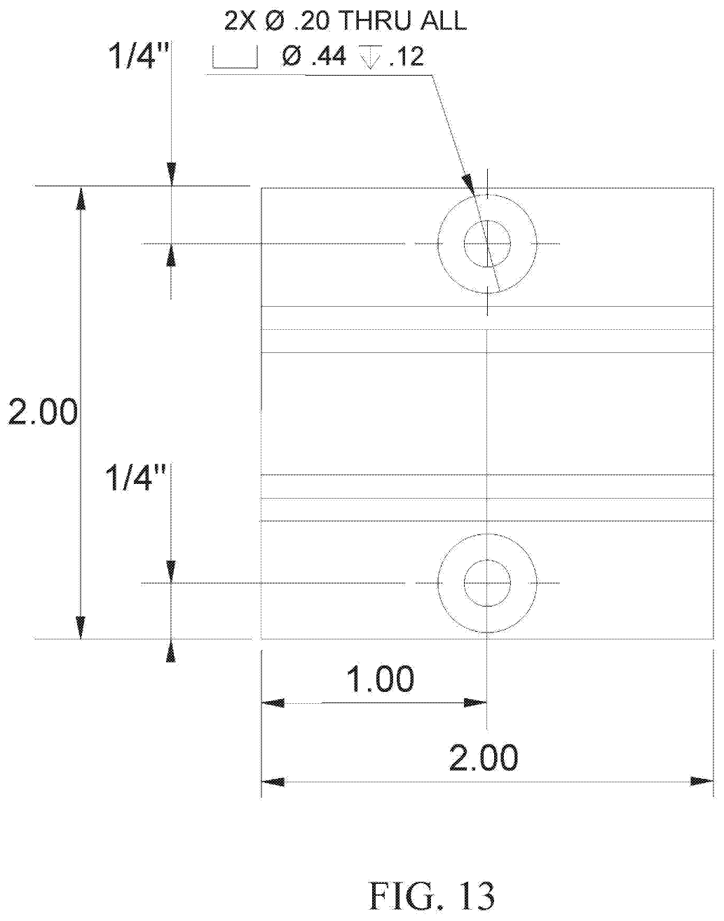

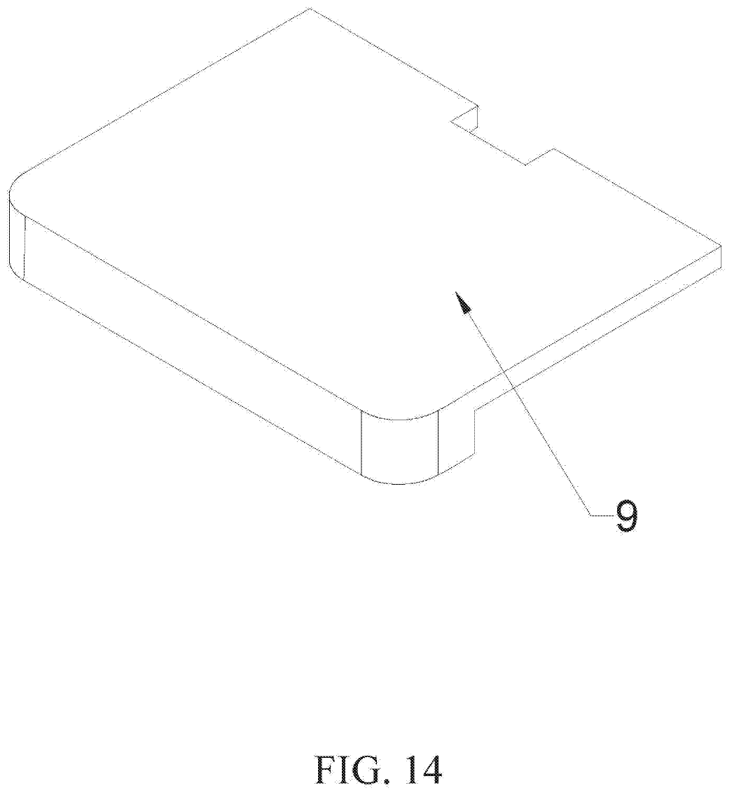

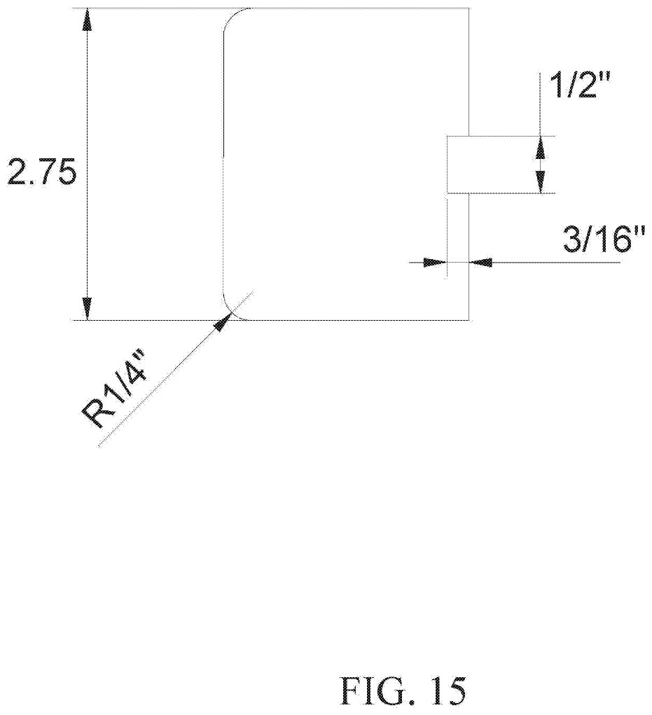

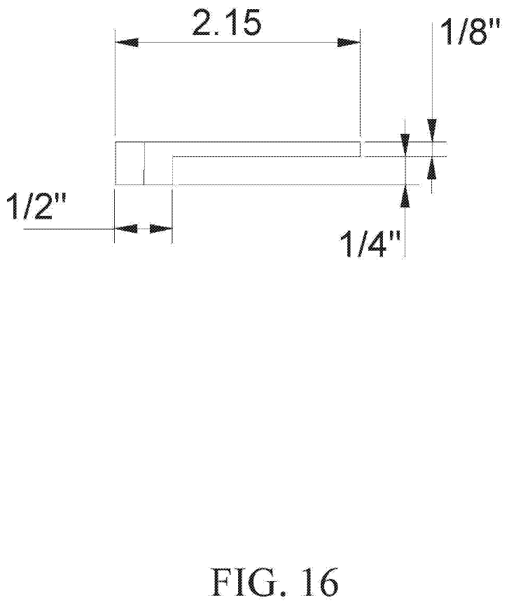

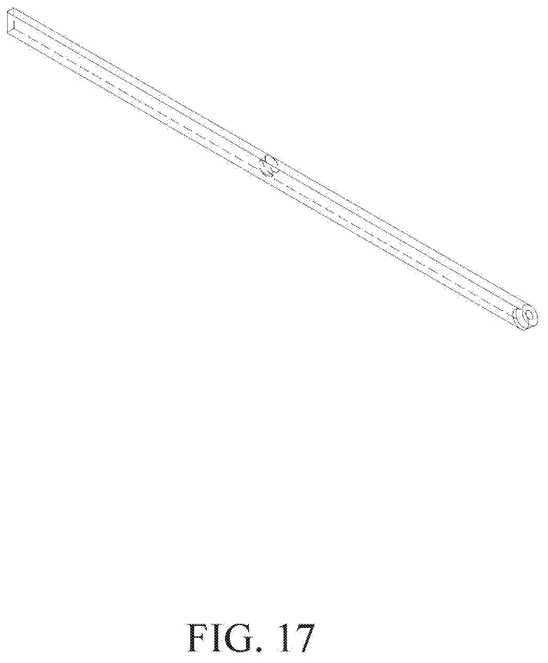

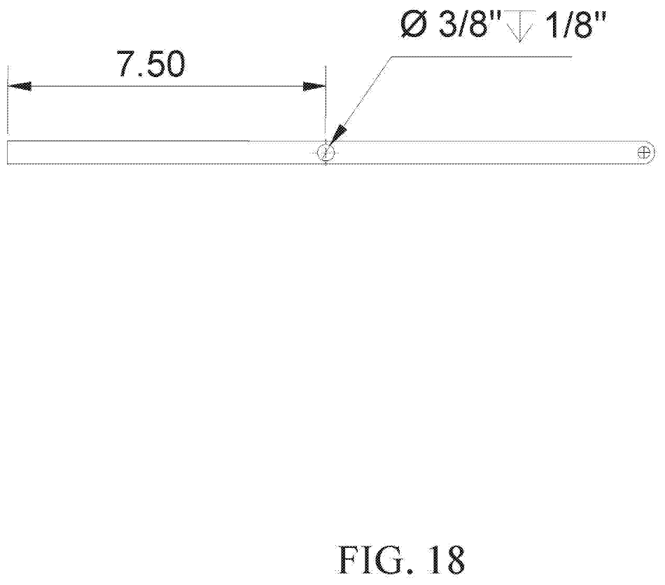

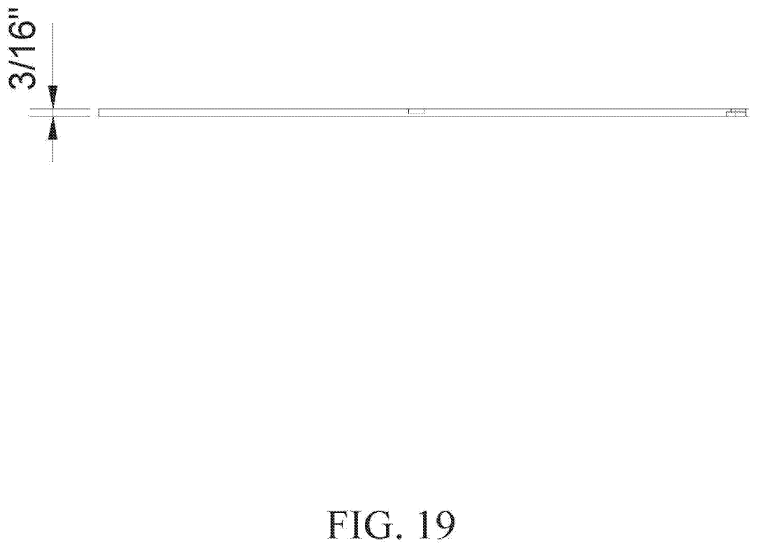

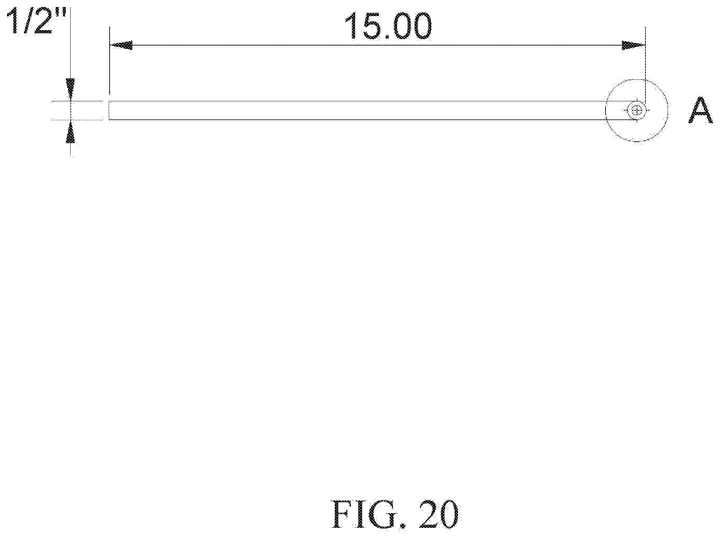

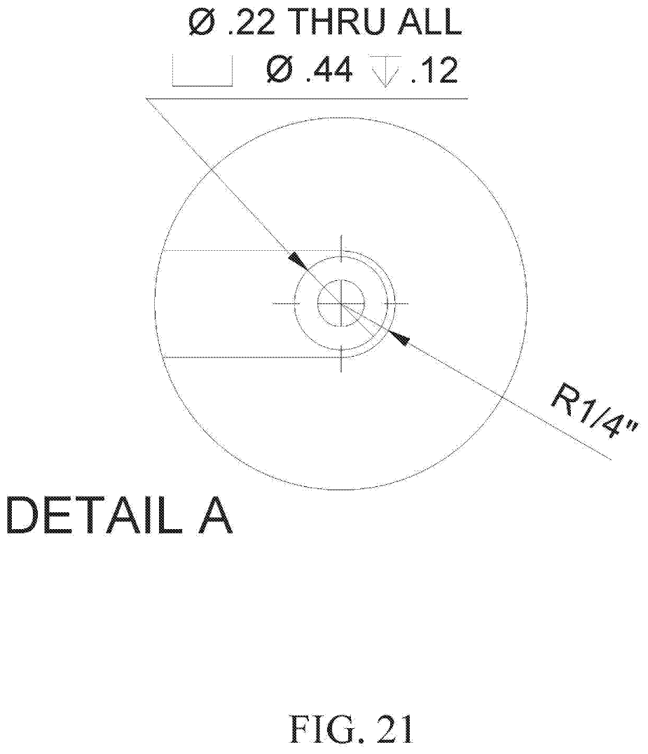

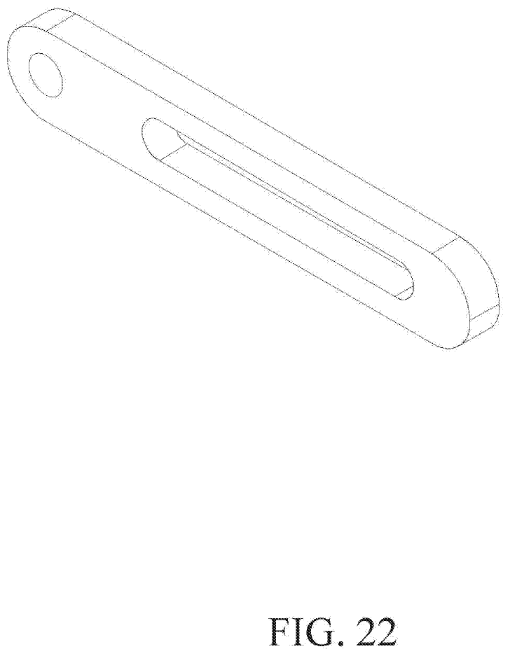

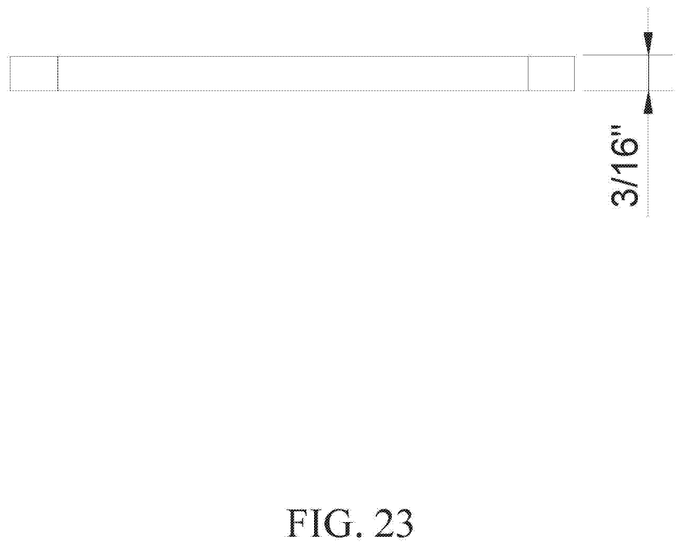

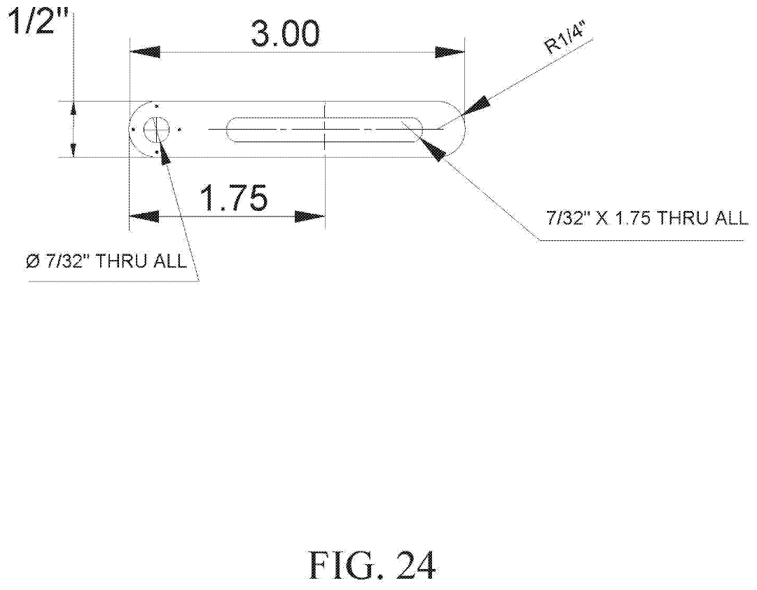

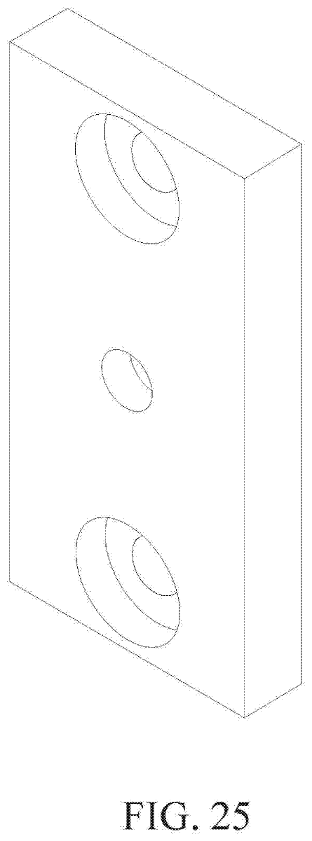

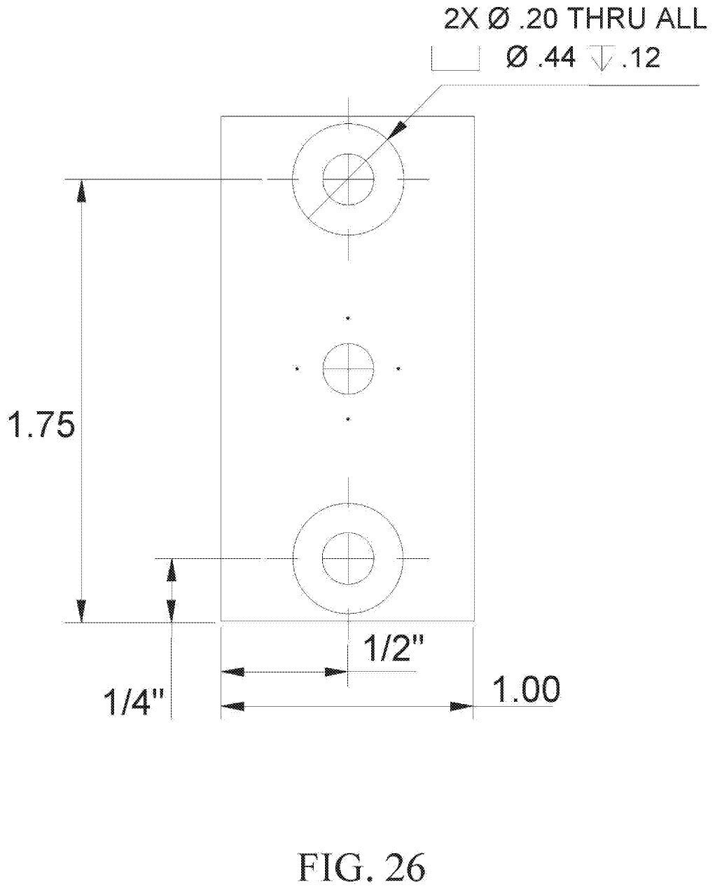

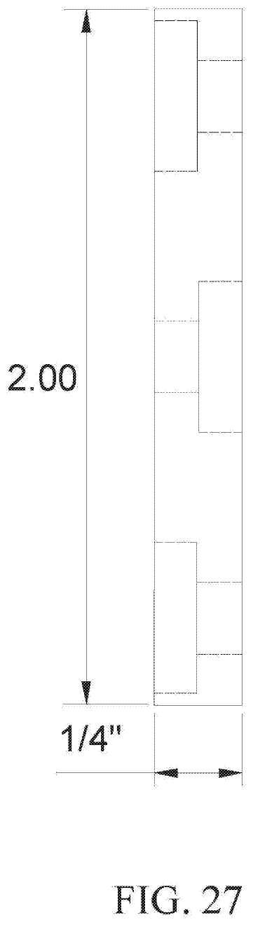

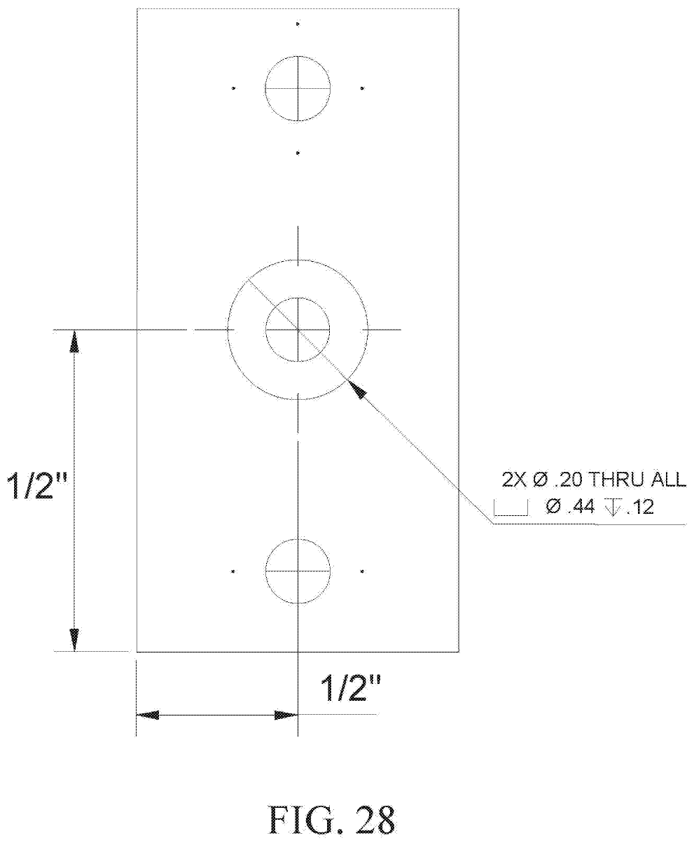

FIGS. 1-29 illustrate the present disclosure of the lock mechanism.

All components of the device and/or apparatus in the disclosure are made from metal but also can be made from composite materials, alloys, plastics, rubber, wood, carbon, foam or equivalent materials which can withstand the forces of opening, closing, locking, unlocking and operating the disclosed device and/or apparatus.

The drawings are not drawn to scale and each component in the device and/or apparatus can be a larger or smaller size, relative the other components, than shown in the drawings. Each component in the device and/or apparatus can have at least one hole, aperture and/or opening and each of the hole(s), aperture(s) and/or opening(s) can be larger and/or smaller than the holes, apertures and openings disclosed and illustrated within the drawings.

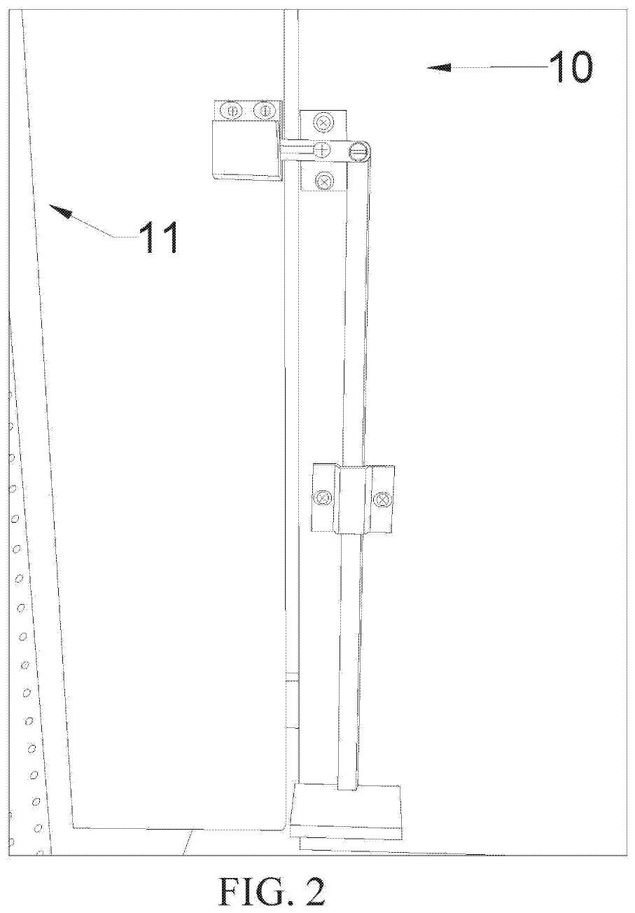

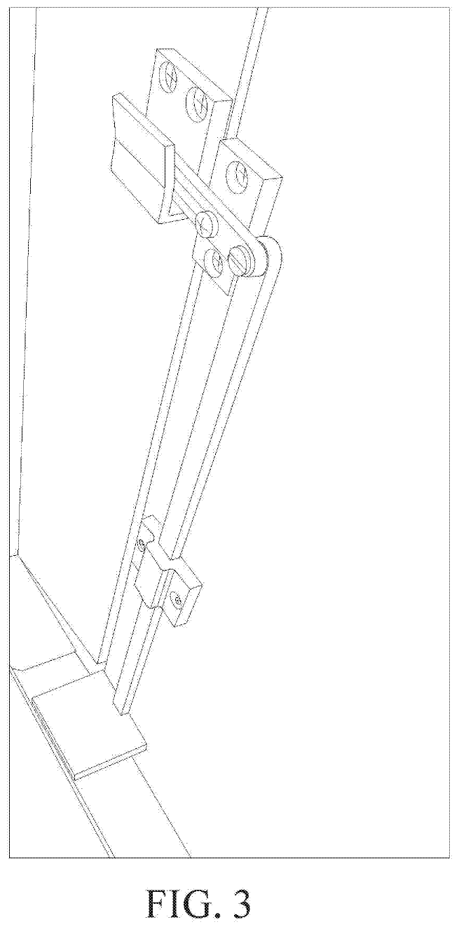

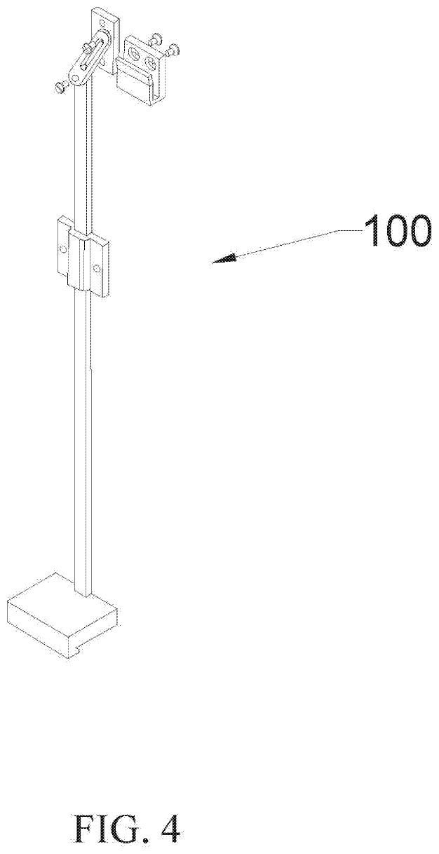

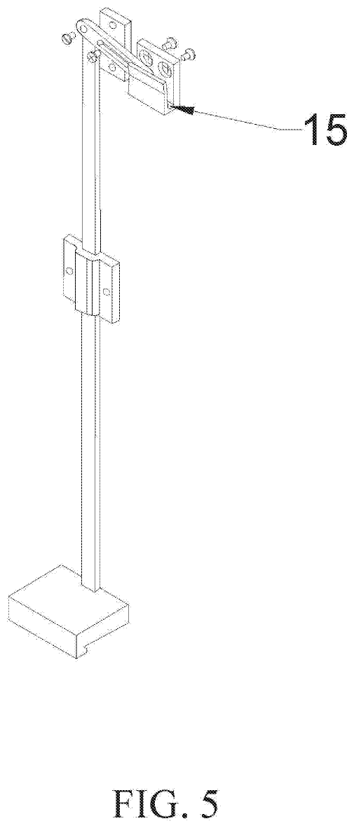

As shown in FIG. 1, FIG. 2, FIG. 3, FIG. 4, and FIG. 5, lock mechanism 100 comprises a pedal 1, a (vertical) rod 2, a rod support 5, a lock means such as a hinge 3, a hinge support 4, a hinge lock 6, and magnet(s) 8. The lock mechanism 100 is designed to allow a person or others to lock and unlock a door 10 and/or a public restroom door/stall without using a user's hand and even to open and close the door without using the user's hand. At a bottom portion or a bottom end of the lock mechanism is the pedal 1 attached to the rod 2 using a weld, any type of bracket and screws or any equivalent attachment means such as holes and fasteners, where the fasteners may be screws, rivets or any other equivalent attachment device(s) or apparatus. The pedal 1 has a flat upper surface in order for any part of the user's leg and/or arm or equivalent body part to move the pedal 1 up and down the rod 2. The pedal 1 and the rod 2 can be made from a single piece or sheet, which is cut and/or bent at a certain point(s) to achieve the desired shape. The material of the piece or sheet is metal or composite materials, alloys, plastics, rubber, wood, carbon, foam or any equivalent material. A non-slip material and/or structure/coating/tape/paint 9, such as a diamond knurl surface finish; grit; epoxy or aggregate, can be wrapped on or installed on the pedal 1 to increase grip. The non-slip material 9 can be manufactured using a stamping method for metal parts or parts of the pedal 1. Also, a sleeve made of rubber can be added to the pedal 1 and the sleeve can wrapped around the pedal 1.

The pedal 1 may have a cut-out such that the cut-out attaches to the rod 2 since the cut-out and the rod have the same shape. The shape of the cut-out and the rod 2 can be circular, elongated, rectangular, square, triangular or any polygonal or geometric shape. In a middle portion of the lock mechanism and/or rod 2, there is/are magnet(s) 8 that work against gravity for the function of holding a lock means in place when locked. In this general location or in the same location of the middle portion of the lock mechanism and/or rod 2 there is the rod support 5 holding the rod 2 against the door/stall 10 to keep the rod 2 vertical at all times. The rod support 5 comprises has two side members 12 and an indentation 13 between the two side members 12 which is the same shape as the rod. The shape of the indentation and the rod 2 can be U-shaped, circular, elongated, rectangular, square, triangular or any polygonal or geometric shape. The rod support 5 also houses an additional/partner magnet 8. On top of the vertical rod 2, there is a hole, which is used for attaching the hinge 3. The hinge 3 is connected to the vertical rod 2 using a clevis pin 7 or equivalent attaching device(s) or apparatus such as screw(s) or rivet(s). The hinge 3 has a groove 14 therein, which enables the hinge 3 to slide up and down. Behind the groove 14, there is the hinge support 4, which attaches/sets the hinge 3 to the door/stall 10 with the clevis pin 7. The hinge 3 can slide on this clevis pin 7 with the function of pushing the pedal 1 down or up the vertical rod 2. The hinge support 4 is attached to a support/wall/door 10. When the pedal 1 is pushed up (up the vertical rod 2) the hinge 3 will lower into a cavity 15 of the hinge lock 6 and the lock mechanism will be in a “locked” mode. To “unlock” the lock mechanism 100, the user is to push the pedal 1 down (down the vertical rod 2), then the hinge 3 will raise out of the cavity 15 of the hinge lock 6 and now the lock mechanism 100 will be in an “unlocked” mode. Then when the user wants to lock the lock mechanism 100 from inside the stall, the user will align the door with the wall/stand 11 of a bathroom stall and then push the pedal 1 up so the hinge 3 will lower into the cavity 15 of the hinge lock 6 and the lock mechanism 100 will be in a “locked” mode and also the bathroom door will now be locked. The hinge lock 6 will be attached/placed on a support/wall/stand 11 that adjoins with the door. Because the pedal 1 is up when locked, the pedal 1 cannot be seen nor opened from outside the enclosed stall if properly installed allowing for safety and solving the problem of allowing the door from being opened by someone outside of the enclosed stall. Therefore, the disclosed invention and lock mechanism prevents someone or something from opening the locked door from outside of the enclosed stall.

The lock mechanism can be placed at any height on the door/stall. The lock mechanism can be operated by a user's feet, knee, hips, or any other part of the user's leg.

Also, the size of any and/or all components of the lock mechanism can be easily, quickly and appropriately adjusted before installation. The height of the lock mechanism can be adjusted to a preferred size, when installing the lock mechanism.

The lock mechanism can be used as an add on to any door with an existing lock.

The lock mechanism can also be installed/placed on a door that does not yet have a lock.

The lock mechanism use is to lock the door and keep unwanted people from entering.

Since the lock mechanism is simple and easy to install, use and operate, any person of almost any height, size and age as well as a disabled person, can safely operate the lock mechanism.

The components of the lock mechanism may be made from metal, composite materials, alloys, plastics, rubber, wood, carbon, foam or equivalent materials which can withstand the forces of opening, closing, locking, unlocking and operating the disclosed device and/or apparatus.

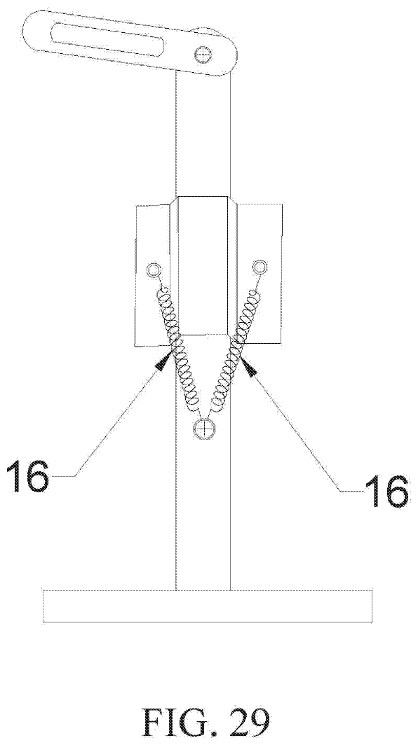

Instead of a magnet(s) 8, the use of spring(s) 16, as shown in FIG. 29, can be used to allow the hinge of the lock mechanism to be in the lock position. This makes it easier to use as you only need to push the pedal 1 down, align the door with the wall/stand of a bathroom stall and release to hinge 3 from the locked position.

The hinge lock 6 can be redesigned and placed on any type of support or bathroom stall fixture, whether the fixture is on a parallel or perpendicular side of the door.

The lock mechanism can be retrofitted to existing doors and provided to manufacturers of bathroom stalls as add on option.

The hinge 3 can be in a different shape, such as a curved or wavy shape and does not have to be in a sliding mechanism and can be used by an up and down (i.e. vertical) or a side-to side (i.e. horizontal, no angular position relative to the ground and/or floor, movement) methods/movements instead of an angular, relative to the ground and/or floor, movement/position.

A catch or a final part where the hinge 3 latches on to, can be designed as a latch mechanism in which alignment of the door 10 is not required to lock. That way the user pulls up the pedal 1 and then pushes the door 10 and this latches and locks. You then push the pedal 1 down and this will unlatch.

Finally, it should be noted that the above embodiments are only used to illustrate the technical aspects of the present disclosure, rather than limit the embodiments. Although the present disclosure has been described in detail with reference to the foregoing embodiments, it should be understood by a person of ordinary skill in the art that the technical aspects described in the embodiments can still be modified or equivalent substitutions can be made to some or all of the technical features and the modifications or substitutions would not change the substance of the scope of the embodiments of the present disclosure.

What is claimed is:

1. A lock mechanism comprising a pedal attached to a lower portion of a rod, a lock means attached to an upper portion of the rod, a rod support attached to the rod between the lock means and the pedal, a hinge support is connected to the lock means, a hinge lock attached to a support and a magnet connected to the rod support.

2. The lock mechanism according to claim 1, wherein the lock means is a hinge.

3. The lock mechanism according to claim 2, wherein the hinge comprises a groove.

4. The lock mechanism according to claim 3, further comprising a pin position within the groove.

5. The lock mechanism according to claim 4, where the pin is a clevis pin.

6. The lock mechanism according to claim 5, wherein the hinge support is positioned behind the groove and the hinge is attached to a door such that the hinge is capable of sliding on the clevis pin when pushing the pedal down and/or up the rod.

7. The lock mechanism according to claim 1, wherein the pedal has a flat upper surface and the pedal is capable of moving up and down the rod.

8. The lock mechanism according to claim 1, wherein the hinge lock comprises a cavity.

9. The lock mechanism according to claim 4, when the pedal is moved upward on the rod, the hinge is moved into the cavity of the hinge lock.

10. The lock mechanism according to claim 4, when the pedal is moved downward on the rod, the hinge is moved out of the cavity of the hinge lock.

11. The lock mechanism according to claim 1, wherein the hinge support is attached to a door.

12. The lock mechanism according to claim 1, wherein the rod support comprises two side members and an indentation between the two side supports which is a same shape as the rod.

13. The lock mechanism according to claim 1, wherein the pedal comprises a cut-out.

14. The lock mechanism according to claim 13, wherein the cut-out has a same shape as the rod.

15. The lock mechanism according to claim 1, wherein the rod comprises at least one hole.

16. The lock mechanism according to claim 2, wherein the hinge comprises at least one hole.

17. The lock mechanism according to claim 12, wherein each of the two side members comprises at least one hole.

18. The lock mechanism according to claim 1, wherein the hinge support comprises at least one hole.

19. The lock mechanism according to claim 1, wherein the hinge lock comprises at least one hole.

20. The lock mechanism according to claim 1, wherein the rod is a vertical rod.
